(19) United States
(12) Patent Application Publication
(10) Pub. No.: US 2009/0268624 A1
(43) Pub. Date: Oct. 29, 2009

(54) SYSTEMS AND METHODS FOR MEASUREMENT AND FEEDBACK OF CHANNEL QUALITY INDICATOR INFORMATION

(75) Inventors: Kimihiko Imamura, Vancouver, WA (US); Shugong Xu, Vancouver, WA (US); Huaming Wu, Vancouver, WA (US)

Correspondence Address: AUSTIN RAPP & HARDMAN, 170 SOUTH MAIN STREET, SUITE 735, SALT LAKE CITY, UT, 84101, US

(73) Assignee: Sharp Laboratories of America, Inc., Camas, WA (US)

(21) Appl. No.: 12/111,078

(22) Filed: Apr. 28, 2008

(51) Int. Cl. G06F 11/00

(52) U.S. Cl. 370/252

(57) ABSTRACT

User equipment may receive configuration information indicating whether the user equipment provides feedback of channel quality indicator (CQI) information in virtual resource block mode or physical resource block mode. If the configuration information indicates that the user equipment provides feedback in virtual resource block mode, the user equipment may calculate the CQI information for virtual resource blocks. The user equipment may feed back the CQI information for the virtual resource blocks to a Node B.

### TECHNICAL FIELD

The present disclosure relates generally to wireless communications and wireless communications-related technology. More specifically, the present disclosure relates to systems and methods for measurement and feedback of channel quality indicator information.

### BACKGROUND

Wireless communication devices have become smaller and more powerful in order to meet consumer needs and to improve portability and convenience. Consumers have become dependent upon wireless communication devices such as cellular telephones, personal digital assistants (PDAs), laptop computers, and the like. Consumers have come to expect reliable service, expanded areas of coverage, and increased functionality.

A wireless communication device may be referred to as user equipment, a mobile station, a subscriber station, an access terminal, a remote station, a user terminal, a terminal, a subscriber unit, etc. The term “user equipment” (UE) will be used herein.

A wireless communication system may provide communication for a number of cells, each of which may be serviced by a Node B. A Node B may be a fixed station that communicates with UEs. A Node B may alternatively be referred to as a base station, an access point, or some other terminology.

UEs may communicate with one or more Node Bs via transmissions on the uplink and the downlink. The uplink (or reverse link) refers to the communication link from the UEs to the Node B, and the downlink (or forward link) refers to the communication link from the Node B to the UEs. A wireless communication system may simultaneously support communication for multiple UEs.

Wireless communication systems may be multiple-access systems capable of supporting communication with multiple users by sharing the available system resources (e.g., bandwidth and transmit power). Examples of such multiple-access systems include code division multiple access (CDMA) systems, time division multiple access (TDMA) systems, frequency division multiple access (FDMA) systems, and orthogonal frequency division multiple access (OFDMA) systems.

### BRIEF DESCRIPTION OF THE DRAWINGS

FIG. 1 illustrates an example showing how virtual resource blocks (VRBs) may be mapped to physical resource blocks (PRBs);

FIG. 2 illustrates a block interleaver corresponding to the VRB-to-PRB mapping scheme shown in FIG. 1;

FIG. 3 illustrates an example of a format of a downlink grant;

FIG. 4 illustrates an example showing how CQI information may be calculated based on PRBs;

FIG. 5 illustrates an example showing how CQI information may be calculated based on VRBs;

FIG. 6 illustrates an example of a method for measurement and feedback of channel quality indicator information;

FIG. 7 illustrates an example of a method for calculating CQI information for a particular virtual resource block;

FIG. 8 illustrates various components that may be utilized to implement the methods shown in FIGS. 6 and 7;

FIG. 9 shows an example of Radio Resource Control (RRC) signaling between a Node B and user equipment;

FIG. 10 shows an example of how to select VRB/PRB CQI feedback;

FIG. 11 shows another example of how to select VRB/PRB CQI feedback;

FIG. 12 shows another example of how to select VRB/PRB CQI feedback; and

FIG. 13 illustrates various components that may be utilized in a wireless device.

### DETAILED DESCRIPTION

The 3rd Generation Partnership Project, also referred to as “3GPP,” is a collaboration agreement that aims to define globally applicable Technical Specifications and Technical Reports for 3rd Generation Systems. 3GPP Long Term Evolution (LTE) is the name given to a project to improve the Universal Mobile Telecommunications System (UMTS) mobile phone or device standard to cope with future requirements. The 3GPP may define specifications for the next generation mobile networks, systems, and devices. In one aspect, UMTS has been modified to provide support and specification for the Evolved Universal Terrestrial Radio Access (E-UTRA) and Evolved Universal Terrestrial Radio Access Network (E-UTRAN).

The examples described herein are relevant to wireless communication systems that are configured in accordance with 3GPP LTE. However, these examples should not be interpreted as limiting the scope of the present disclosure. The systems and methods described herein may also be applicable in other wireless communication systems that utilize orthogonal frequency division multiplexing (OFDM), such as IEEE 802.16m.

The downlink transmission scheme for a 3GPP LTE system is based on OFDM. In an OFDM system, the available spectrum is divided into multiple carriers, called sub-carriers. Each of these sub-carriers is independently modulated by a low rate data stream.

Orthogonal frequency division multiple access (OFDMA) allows the access of multiple users on the available bandwidth. Each user may be assigned a specific time-frequency resource. The data channels may be shared channels; i.e., for each transmission time interval, a new scheduling decision may be taken regarding which users are assigned to which time/frequency resources during that transmission time interval.

A radio frame may be divided into a certain number of equally sized slots. A sub-frame may consist of two consecutive slots.

Several different channels are defined for a 3GPP LTE system. For transmission on the downlink, user data is carried on the physical downlink shared channel (PDSCH). Downlink control signaling on the physical downlink control channel (PDCCH) is used to convey the scheduling decisions to individual UEs. The PDCCH is located in the first OFDM symbols of a subframe.

Modulation and coding for the shared data channel is not fixed, but is adapted according to radio link quality. The UEs regularly report channel quality indicator (CQI) information to the Node B.

For transmission on the uplink, user data is carried on the physical uplink shared channel (PUSCH). The physical uplink control channel (PUCCH) carries uplink control information, e.g., CQI reports and ACK/NACK information related to data packets received in the downlink. The UE uses the PUCCH when it does not have any data to transmit on the PUSCH. If the UE has data to transmit on the PUSCH, the UE multiplexes the control information with data on the PUSCH. In the downlink, acknowledgement/negative acknowledgement (ACK/NACK) information is sent on a physical hybrid ARQ indicator channel (PHICH).

Data is allocated to the UEs in terms of resource blocks. Resource blocks are used to describe the mapping of certain physical channels to resource elements. Physical resource blocks and virtual resource blocks are defined.

A physical resource block is defined as a certain number of consecutive OFDM symbols in the time domain and a certain number of consecutive subcarriers in the frequency domain.

A virtual resource block is of the same size as a physical resource block. Two types of virtual resource blocks are defined: virtual resource blocks of localized type, and virtual resource blocks of distributed type.

Virtual resource blocks of localized type are mapped directly to physical resource blocks such that virtual resource block n_{VRB} corresponds to physical resource block n_{PRB}=n_{VRB}.

Virtual resource blocks of distributed type are mapped to physical resource blocks such that virtual resource block n_{VRB} corresponds to physical resource block n_{PRB}=f(n_{VRB},nₛ), where nₛ is the slot number within a radio frame. The virtual-to-physical resource block mapping is different in the two slots of a subframe.

In a 3GPP LTE system, there are two typical schemes to transmit signals. One scheme is distributed transmission, and another scheme is localized transmission. In the case of localized transmission, data allocation in the VRB (virtual resource block) is the same as in the PRB (physical resource block). However, in the case of distributed transmission, data is allocated by using VRB-to-PRB mapping.

The present disclosure proposes a method of CQI measurement and feedback based on either VRB or PRB mapping to optimize feedback information for distributed or localized transmission and associated switching mechanisms.

A method for measurement and feedback of channel quality indicator (CQI) information is disclosed. The method may be implemented by user equipment. The method may include receiving configuration information indicating whether the user equipment provides feedback of the CQI information in virtual resource block mode or physical resource block mode. If the configuration information indicates that the user equipment provides feedback in virtual resource block mode, the method may also include calculating the CQI information for virtual resource blocks. The method may also include feeding back the CQI information for the virtual resource blocks to a Node B.

Calculating the CQI information for a particular virtual resource block may include calculating the CQI information for multiple physical resource blocks corresponding to the virtual resource block, and determining the CQI information for the virtual resource block based on the CQI information that is calculated for the multiple physical resource blocks.

Determining the CQI information for the virtual resource block based on the CQI information that is calculated for the multiple physical resource blocks may include averaging CQI values that are calculated for the multiple physical resource blocks. Alternatively, determining the CQI information for the virtual resource block based on the CQI information that is calculated for the multiple physical resource blocks may include selecting a maximum CQI value from CQI values that are calculated for the multiple physical resource blocks. Alternatively, determining the CQI information for the virtual resource block based on the CQI information that is calculated for the multiple physical resource blocks may include selecting a minimum CQI value from CQI values that are calculated for the multiple physical resource blocks.

The configuration information may be received via Radio Resource Control signaling. The configuration information may include a virtual resource block flag that is included within physical uplink control channel (PUCCH) resource allocation.

The configuration information may include a virtual resource block flag that is included within physical downlink shared channel (PDSCH) resource allocation.

The configuration information may be received via L1/L2 signaling. The configuration information may include a virtual resource block flag that is included within physical downlink control channel (PDCCH) control signaling.

User equipment (UE) that is configured for measurement and feedback of channel quality indicator (CQI) information is also disclosed. The UE includes a processor and memory in electronic communication with the processor. Instructions are stored in the memory. The instructions may be executable to receive configuration information indicating whether the user equipment provides feedback of the CQI information in virtual resource block mode or physical resource block mode. If the configuration information indicates that the user equipment provides feedback in virtual resource block mode, the instructions may also be executable to calculate the CQI information for virtual resource blocks. The instructions may also be executable to feed back the CQI information for the virtual resource blocks to a Node B.

A Node B (NB) that configures user equipment (UE) to measure and provide feedback of channel quality indicator (CQI) information is also disclosed. The NB includes a processor, and memory in electronic communication with the processor. Instructions are stored in the memory. The instructions may be executable to send configuration information which indicates whether the UE provides feedback of the CQI information in virtual resource block mode or physical resource block mode. The instructions may also be executable to receive the CQI information from UEs. The instructions may also be executable to decide a modulation and coding scheme that is used for data transmission for each UE based at least on the received CQI information and the configuration information.

A computer-readable medium for facilitating measurement and feedback of channel quality indicator (CQI) information is also disclosed. The computer-readable medium includes executable instructions. The instructions may be executable to receive configuration information indicating whether user equipment provides feedback of the CQI information in virtual resource block mode or physical resource block mode. If the configuration information indicates that the user equipment provides feedback in virtual resource block mode, the instructions may also be executable to calculate the CQI information for virtual resource blocks. The instructions may also be executable to feed back the CQI information for the virtual resource blocks to a Node B.

In accordance with the present disclosure, a UE calculates CQI feedback information based on either the virtual resource blocks (VRBs) or the physical resource blocks (PRBs). The NB selects one scheme for each UE from the above two. The Node B (NB) configures whether the UE provides feedback in VRB or PRB mode. This configuring may be done, for example, via RRC (Radio Resource Control) signaling or L1/L2 signaling (on the PDCCH).

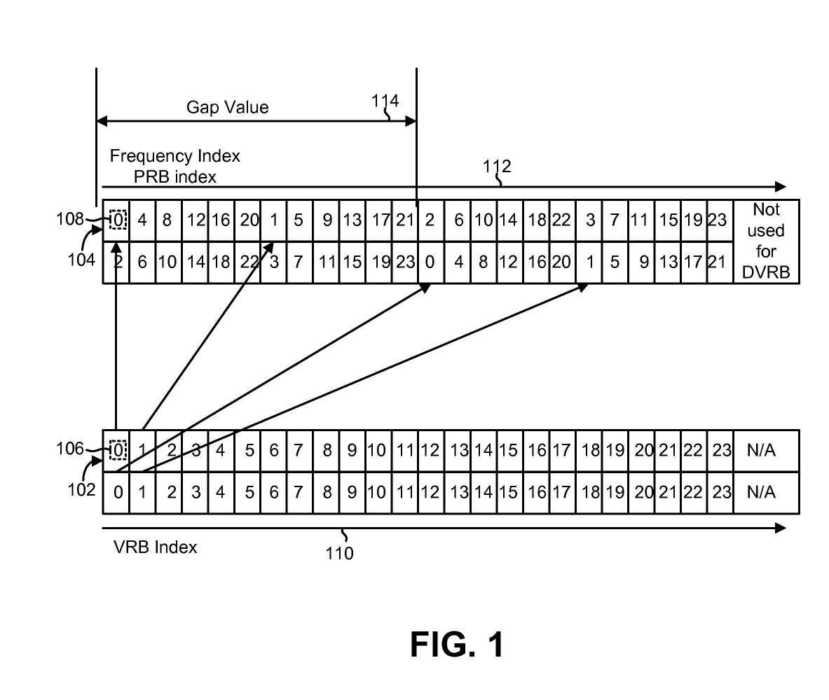

VRB-to-PRB mapping provides frequency diversity by distributing the data to the entire system bandwidth. FIG. 1 illustrates an example showing how VRBs 102 may be mapped to PRBs 104. Each VRB 102 has an index 106 associated with it, and each PRB 104 has an index 108 associated with it. The index 106 associated with a particular VRB 102 will be referred to as the VRB index 106, and the index 108 associated with a particular PRB 104 will be referred to as the PRB index 108.

A horizontal axis 110 is shown adjacent the VRBs 102. Movement in a left-to-right direction along the horizontal axis 110 corresponds to increasing values of the VRB index 106.

A horizontal axis 112 is shown adjacent the PRBs 104. Movement in a left-to-right direction along the horizontal axis 112 corresponds to increasing frequency.

As shown in FIG. 1, VRB-to-PRB mapping allows data to be distributed in the frequency domain in order to provide frequency diversity. 3GPP specified 1 VRB index corresponding to 2 PRB index, which means Nd is always two in 3GPP LTE.

FIG. 1 also shows the gap value 114. As shown, slot 1 in PRB 104 and slot 2 in PRB 104 have a shifted structure. The gap value 114 indicates how much we should shift to create slot 2 mapping from slot 1 mapping.

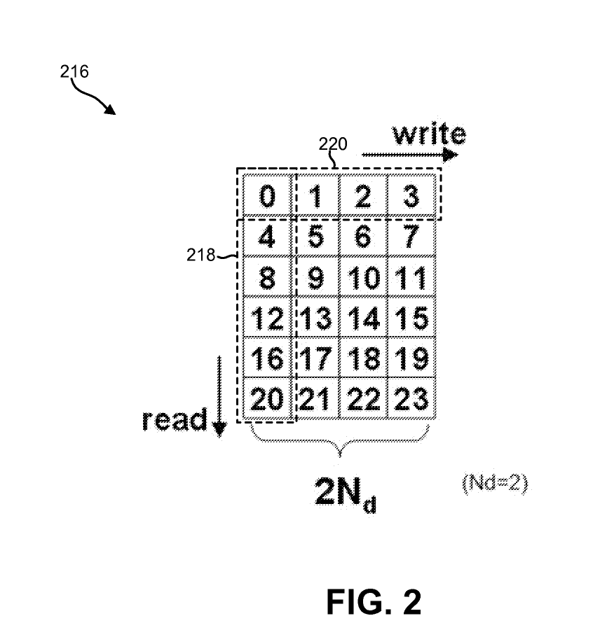

The mapping of VRB indices 106 to PRB indices 108 in FIG. 1 is defined by a block interleaver 216 in FIG. 2. The block interleaver 216 will be specified in 3GPP LTE.

Nd is two in 3GPP LTE. So, there are 4 columns 218 in the block interleaver 216 shown in FIG. 2. The number of rows 220 in the block interleaver 216 shown in FIG. 2 is N_{RB}/4Nd, where N_{RB} is the number of RBs (resource blocks) in the whole system bandwidth. Therefore, to define the block interleaver 216, only N_{RB} information is needed.

The gap value 114 in FIG. 1 is also defined by N_{RB}. So if both the UE and the NB know N_{RB}, there is no need to use any signaling between the NB and the UE to communicate the mapping of VRB indices 106 to PRB indices 108 in FIG. 1.

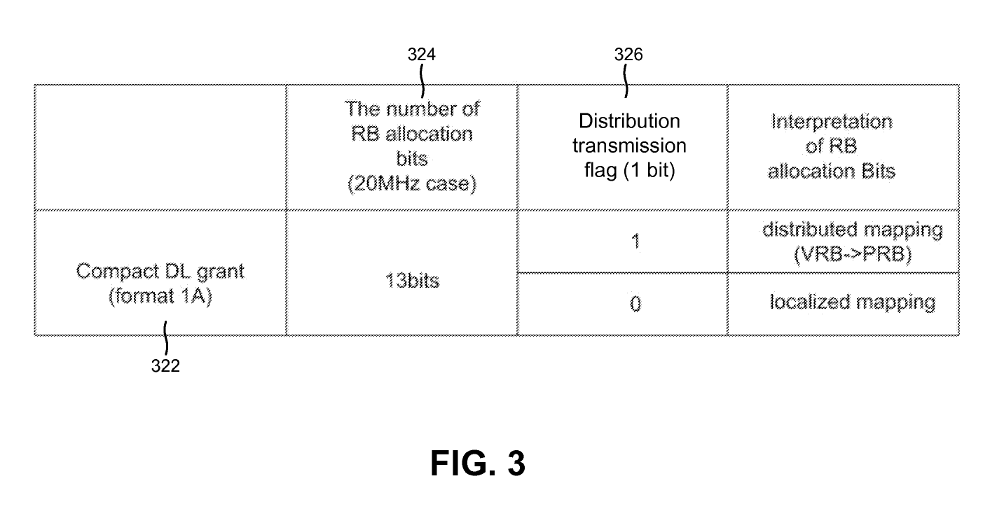

FIG. 3 illustrates an example of a format of a downlink grant 322. This format of a downlink grant 322 includes control information for the PDSCH, such as RB assignment 324 (i.e., the number of RB allocation bits), modulation and coding scheme (MCS), distribution transmission flag 326, etc.

The distribution transmission flag 326 indicates whether the mapping of resource blocks 102, 104 will be localized or distributed. In the case of localized mapping, VRB indices 106 are mapped directly to PRB indices 108. But in the case of distributed mapping, VRB indices 106 are mapped to PRB indices 108 as shown in FIG. 1.

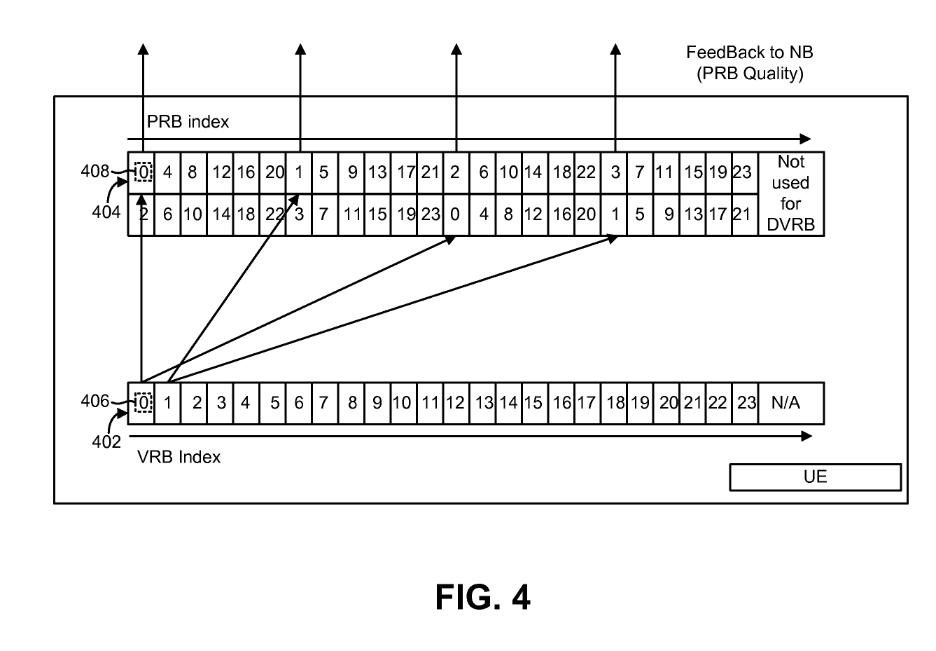

Referring to FIG. 4, currently in 3GPP LTE systems, CQI information is calculated based on each physical resource block 404. So if the UE is in distributed transmission mode, the NB needs all of the CQI information of the physical resource blocks 404 which correspond to each virtual resource block 402. In the example shown in FIG. 4, the UE feeds back CQI information corresponding to 4 PRB indices 408 in order to provide CQI information which corresponds to 2 VRB indices 406.

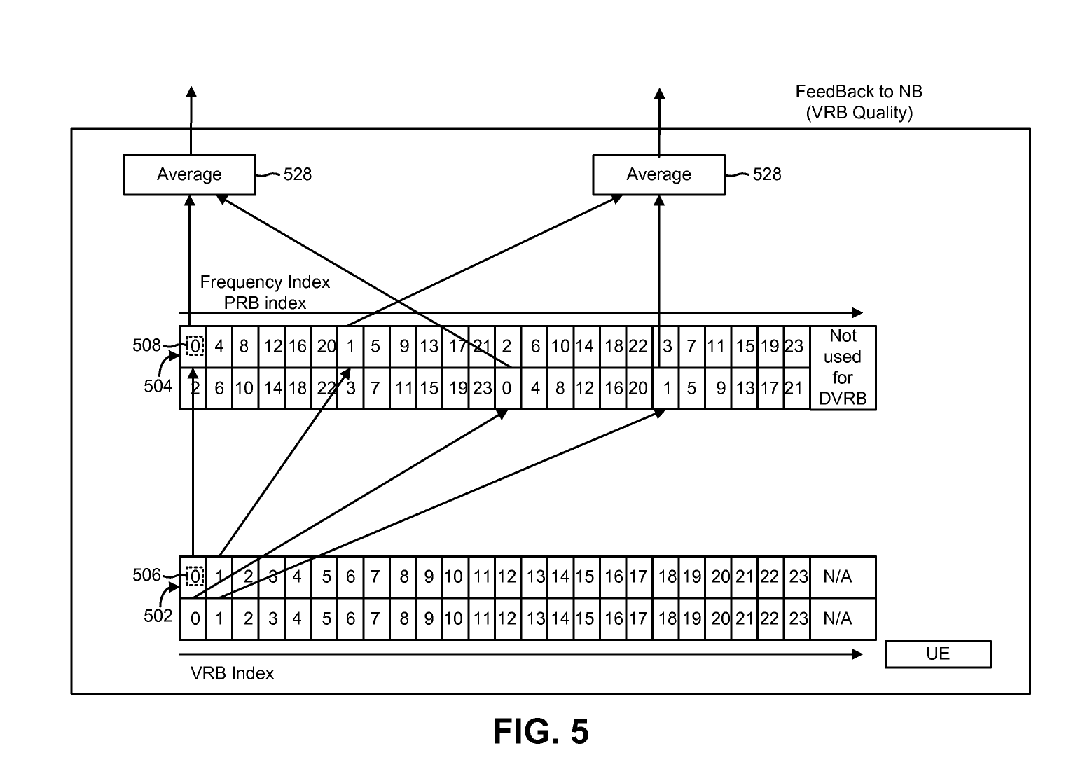

Referring to FIG. 5, the present disclosure proposes to calculate CQI values based on each virtual resource block 502 instead of the above scheme and to select one scheme from these schemes. FIG. 5 shows how to calculate CQI information based on virtual resource blocks 502.

In accordance with the present disclosure, the UE may measure the quality of each physical resource block 504 and calculate the average 528 of two physical resource blocks 504 which are included in one virtual resource block 502. The UE may then feed back only one CQI value for each virtual resource block 502. Taking the average 528 is just one example. A different function (e.g., taking the minimum or taking the maximum) may be used instead of averaging. Another example could be a way which maximizes the bits carried in the two PRB of this VRB, e.g. new MCS.

Thus, in the example shown in FIG. 5, the UE only feeds back CQI information which corresponds to 2 virtual resource blocks 502, instead of CQI information which corresponds to 4 physical resource blocks 504 (as was the case in the example shown in FIG. 4). If we assume that CQI information for both virtual resource blocks 502 and physical resource blocks 504 will be carried by k bits per resource block, CQI information which corresponds to 2 virtual resource blocks 502 needs 2k bits and CQI information which corresponds to 4 physical resource blocks 104 needs 4k bits. Therefore, we can reduce the number of feedback bits to half compared to the approach illustrated in FIG. 4 in the case of distributed transmission.

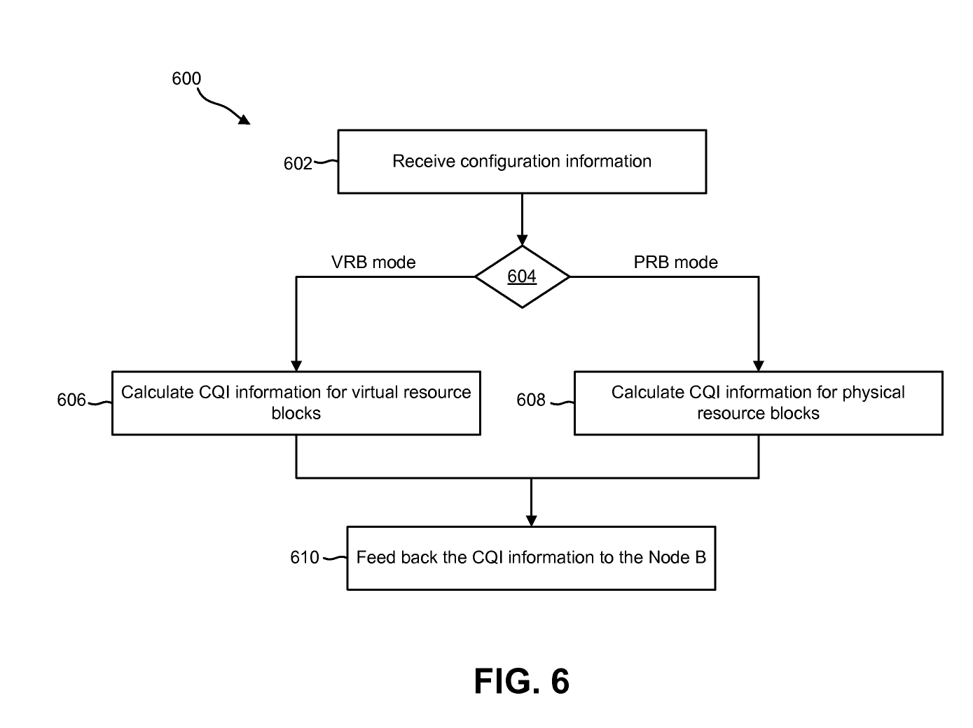

FIG. 6 illustrates an example of a method 600 for measurement and feedback of channel quality indicator (CQI) information. The method 600 may be implemented by user equipment (UE).

The method 600 may include receiving 602 configuration information. The configuration information may be received from the Node B. The configuration information may indicate whether the UE should provide feedback of CQI information in virtual resource block mode or physical resource block mode.

If the configuration information indicates 604 that the UE should provide feedback of CQI information in physical resource block mode, then the UE calculates 608 CQI information for physical resource blocks 104. However, if the configuration information indicates 604 that the UE should provide feedback of CQI information in virtual resource block mode, then the UE calculates 606 CQI information for virtual resource blocks 602. The UE then feeds back 610 the CQI information to the Node B.

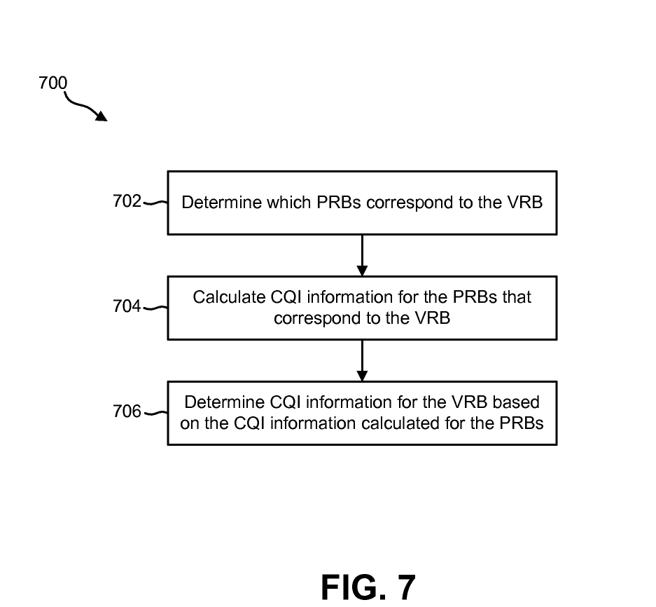

FIG. 7 illustrates an example of a method 700 for calculating CQI information for a particular virtual resource block 102. The method 700 may include determining 702 which physical resource blocks 104 correspond to the virtual resource block 102. The method 700 may also include calculating 704 CQI information for the physical resource blocks 104 that correspond to the virtual resource block 102.

The method 700 may also include determining 706 CQI information for the virtual resource block 102 based on the CQI information that is calculated for the corresponding physical resource blocks 104. For example, the CQI values that are calculated for the physical resource blocks 104 may be averaged. As another example, the maximum of the CQI values that are calculated for the physical resource blocks 104 may be selected. As another example, the minimum of the CQI values that are calculated for the physical resource blocks 104 may be selected.

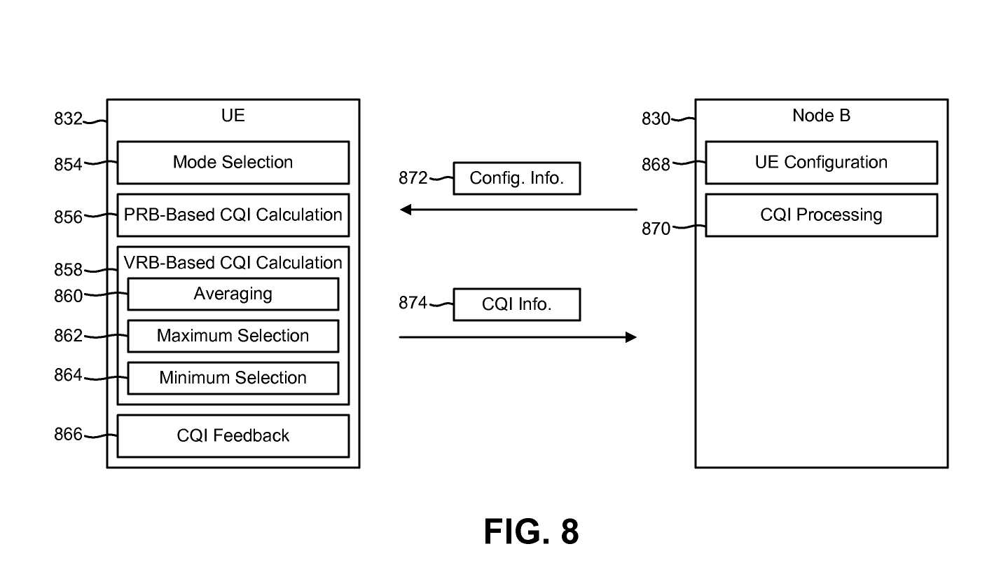

FIG. 8 illustrates various components that may be utilized to implement the methods 600, 700 shown in FIGS. 6 and 7.

User equipment (UE) 832 is shown. The UE 832 may include a mode selection component 854. The mode selection component 854 may be configured to determine whether the UE 832 operates in PRB mode (where CQI information is calculated for physical resource blocks 104) or VRB mode (where CQI information is calculated for virtual resource blocks 102). This determination may be made based on configuration information 872. The configuration information 872 may be received from a Node B 830. The Node B 830 may include a UE configuration component 868, which may be configured to send the configuration information 872 to the UE 832.

The UE 832 may also include a PRB-based CQI calculation component 856. The PRB-based CQI calculation component 856 may be configured to calculate CQI information for physical resource blocks (PRBs) 104. The PRB-based CQI calculation component 856 may be utilized to calculate CQI information if the UE 832 is configured to operate in PRB mode.

The UE 832 may also include a VRB-based CQI calculation component 858. The VRB-based CQI calculation component 858 may be configured to calculate CQI information for virtual resource blocks (VRBs) 102. The VRB-based CQI calculation component 858 may be utilized to calculate CQI information if the UE 832 is configured to operate in VRB mode.

In order to calculate CQI information for a particular virtual resource block 102, the VRB-based CQI calculation component 858 may be configured to determine which physical resource blocks 104 correspond to the virtual resource block 102, calculate CQI information for the physical resource blocks 104 that correspond to the virtual resource block 102, and determine CQI information for the virtual resource block 102 based on the CQI information that is calculated for the physical resource blocks 104. For example, the CQI values that are calculated for the physical resource blocks 104 may be averaged. The VRB-based CQI calculation component 858 may include an averaging component 860 for providing this functionality. Alternatively, the maximum of the CQI values that are calculated for the physical resource blocks 104 may be selected. The VRB-based CQI calculation component 858 may include a maximum selection component 862 for providing this functionality. Alternatively, the minimum of the CQI values that are calculated for the physical resource blocks 104 may be selected. The VRB-based CQI calculation component 858 may include a minimum selection component 864 for providing this functionality.

The UE 832 may also include a CQI feedback component 866, which may be configured to send CQI information 874 to the Node B 830. The Node B 830 may include a CQI processing component 870, which may be configured to process the CQI information 874 that is received from the UE 832.

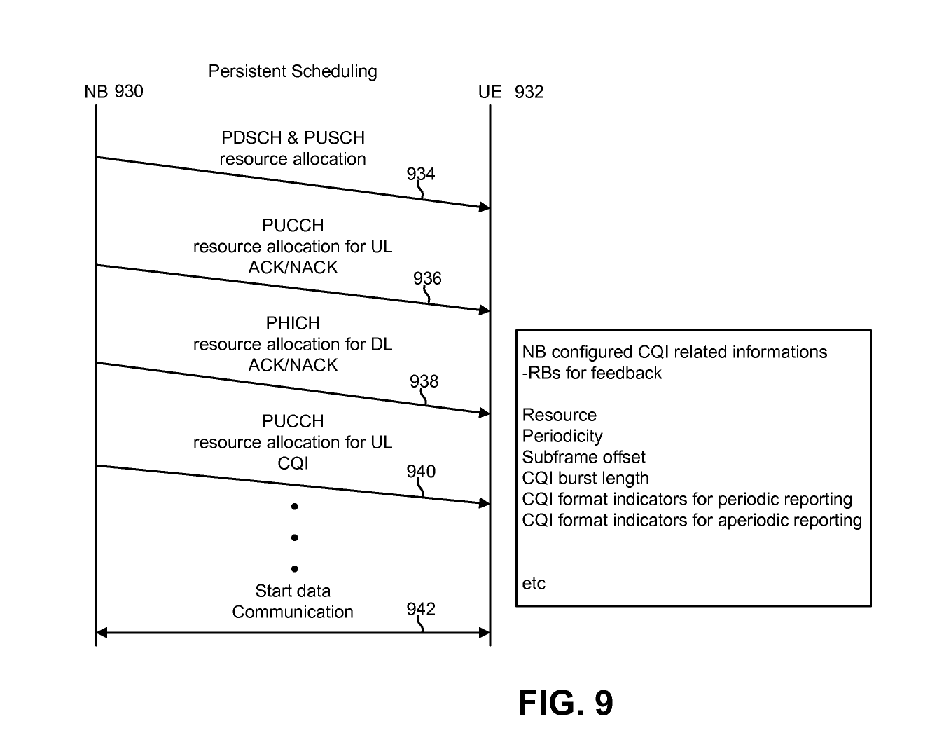

FIG. 9 shows an example of Radio Resource Control (RRC) signaling between the NB 930 and the UE 932. In this example, the NB 930 sends the PDSCH and PUSCH resource allocation 934 to the UE 932. Then the NB 930 sends the PUCCH resource allocation 936 for the uplink ACK/NACK to the UE 932. Then the NB 930 sends the PHICH resource allocation 938 for the downlink ACK/NACK to the UE 932. Then the NB 930 sends the PUCCH resource allocation 940 for the uplink CQI to the UE 932. Then data communication 942 starts. Thus, as shown in this Figure, the NB 930 configures data resources (PDSCH/PUSCH resource allocation) and control signaling resources (PUCCH/PHICH resource allocation) before the NB 930 and the UE 932 exchange the data signals.

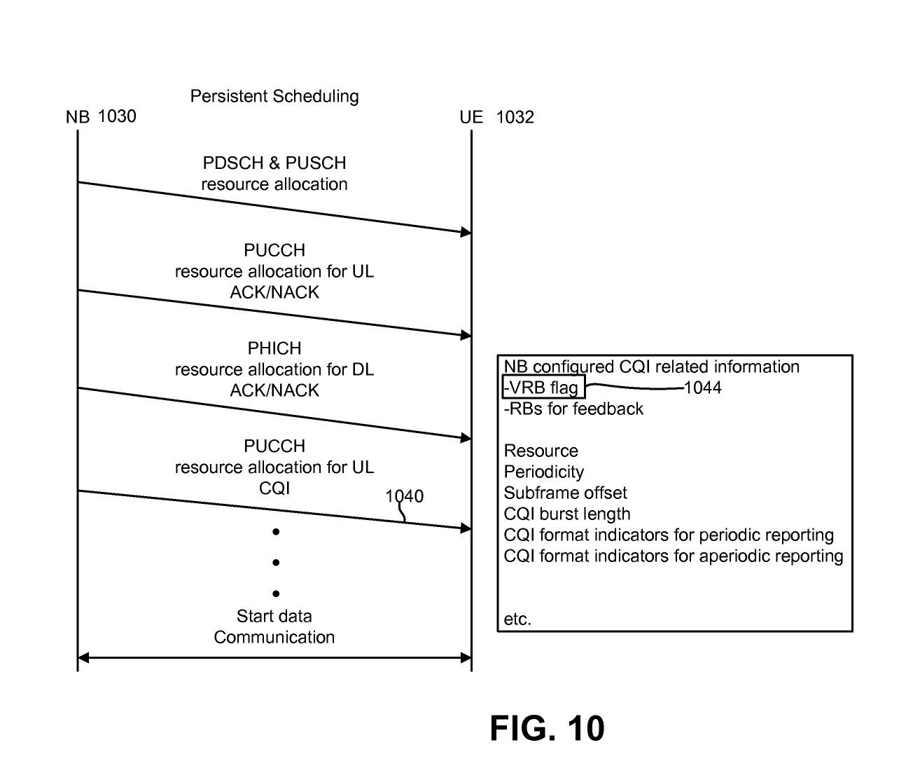

FIG. 10 shows an example of how to select the VRB/PRB CQI feedback as described above. As shown in this Figure, the PUCCH resource allocation related RRC signaling from the Node B 1030 includes a “VRB flag” 1044. In particular, the VRB flag 1044 is included in the PUCCH resource allocation 1040 for the uplink CQI. Based on this VRB flag 1044, the UE 1032 decides which format it will use, i.e., PRB feedback (FIG. 4) or VRB feedback (FIG. 5).

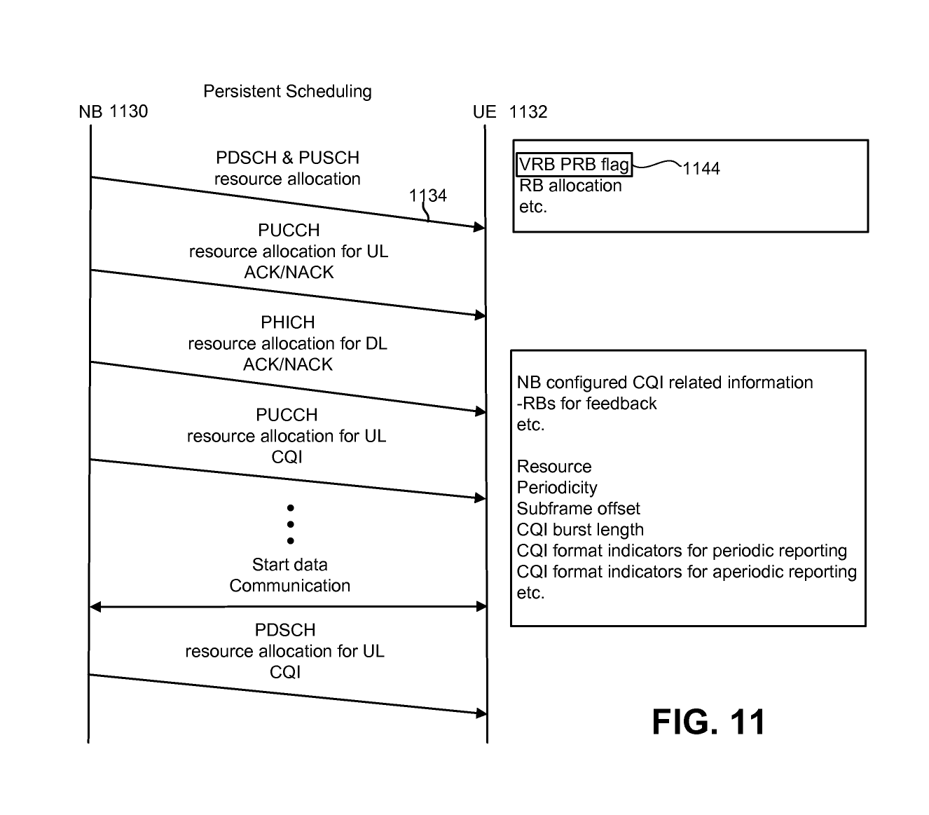

FIG. 11 shows another example of how to select the VRB/PRB CQI feedback as described above. In this Figure, PDSCH resource allocation 1134 related RRC signaling from the Node B 1130 includes a “VRB flag” 1144, which is to indicate VRB or PRB for persistent data transmission. Based on this VRB flag 1144, the UE 1132 decides which format will be used, i.e., PRB feedback (FIG. 4) or VRB feedback (FIG. 5).

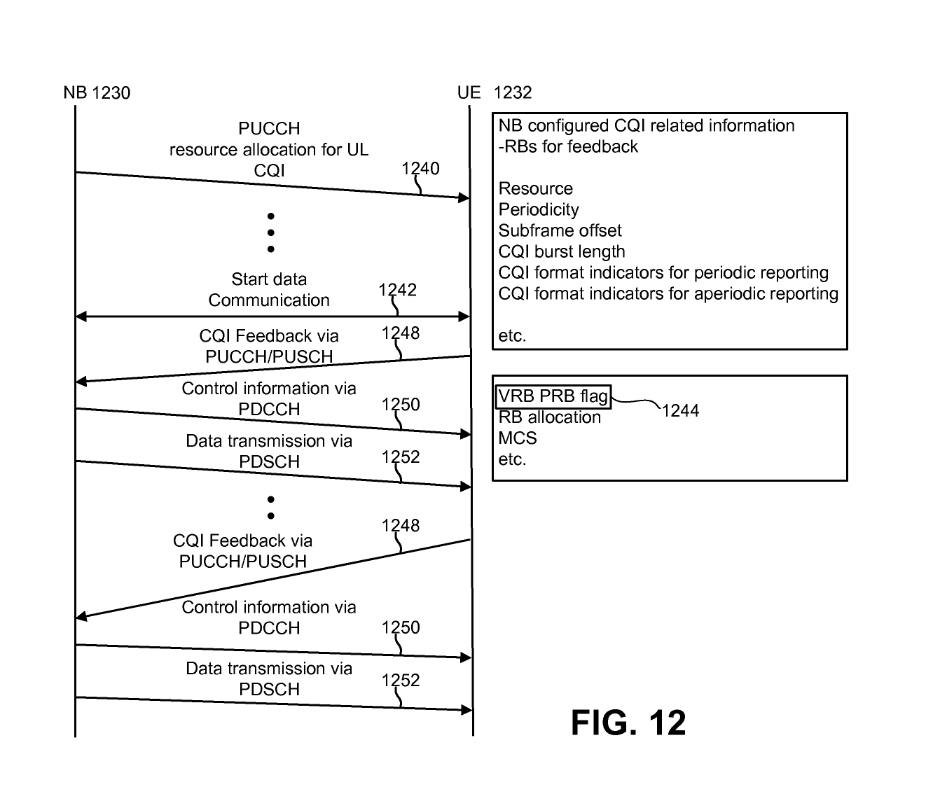

The cases shown in FIGS. 9 through 11 were for persistent scheduling, where configuration information is sent via RRC signaling, since the NB changes the RB allocation and the MCS infrequently. FIG. 12 shows an example of how to select the VRB/PRB CQI feedback in dynamic scheduling, where configuration information is sent via L1/L2 signaling (i.e., via PDCCH), since the NB changes the RB allocation and the MCS frequently.

FIG. 12 illustrates RRC and L1/L2 signaling between the NB 1230 and the UE 1232. The NB 1230 sends PUCCH resource allocation 1240 for the uplink CQI to the UE 1232. Data communication 1242 between the NB 1230 and the UE 1232 starts. The UE 1232 sends CQI feedback 1248 to the NB 1230 via the PUCCH/PUSCH. The NB 1230 sends control information 1250 to the UE 1232 via the PDCCH. Data transmission 1252 from the NB 1230 to the UE 1232 occurs via the PDSCH.

As shown in FIG. 12, control signaling on the PDCCH includes the “VRB flag” 1244, which is to indicate VRB or PRB for dynamic data transmission. Based on this VRB flag 1244, the UE 1232 decides which format it will use, i.e. PRB feedback (FIG. 4) or VRB feedback (FIG. 5).

The examples described above were relevant to 3GPP LTE. However, these examples should not be interpreted as limiting the scope of the present disclosure. The present disclosure is also applicable in other OFDM communication systems, such as IEEE 802.16m.

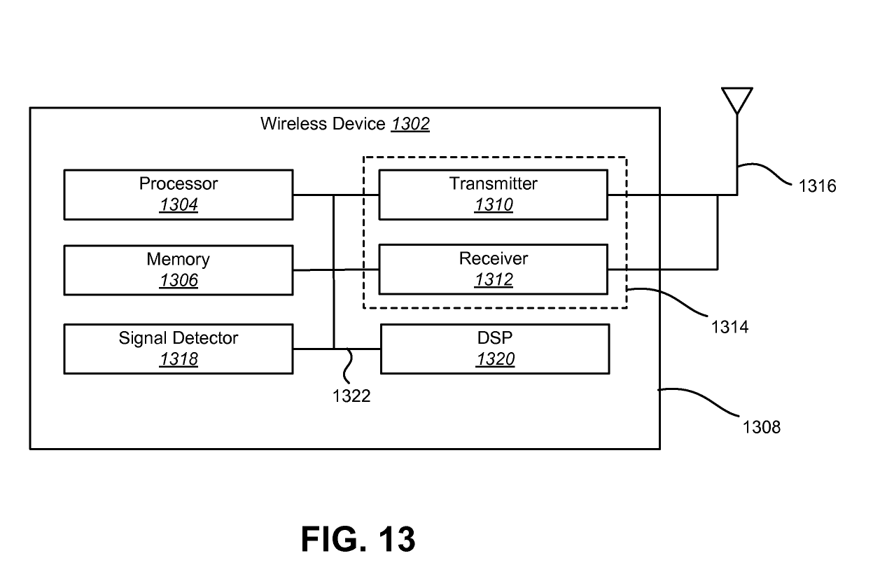

FIG. 13 illustrates various components that may be utilized in a wireless device 1302. The wireless device 1302 is an example of a device that may be configured to implement the methods described herein. The wireless device 1302 may be a base station or a mobile station.

The wireless device 1302 may include a processor 1304 which controls operation of the wireless device 1302. The processor 1304 may also be referred to as a central processing unit (CPU). Memory 1306, which may include both read-only memory (ROM) and random access memory (RAM), provides instructions and data to the processor 1304. A portion of the memory 1306 may also include non-volatile random access memory (NVRAM). The processor 1304 typically performs logical and arithmetic operations based on program instructions stored within the memory 1306. The instructions in the memory 1306 may be executable to implement the methods described herein.

The wireless device 1302 may also include a housing 1308 that may include a transmitter 1310 and a receiver 1312 to allow transmission and reception of data between the wireless device 1302 and a remote location. The transmitter 1310 and receiver 1312 may be combined into a transceiver 1314. An antenna 1316 may be attached to the housing 1308 and electrically coupled to the transceiver 1314. The wireless device 1302 may also include (not shown) multiple transmitters, multiple receivers, multiple transceivers and/or multiple antenna.

The wireless device 1302 may also include a signal detector 1318 that may be used to detect and quantify the level of signals received by the transceiver 1314. The signal detector 1318 may detect such signals as total energy, pilot energy per pseudonoise (PN) chips, power spectral density, and other signals. The wireless device 1302 may also include a digital signal processor (DSP) 1320 for use in processing signals.

The various components of the wireless device 1302 may be coupled together by a bus system 1322 which may include a power bus, a control signal bus, and a status signal bus in addition to a data bus. However, for the sake of clarity, the various buses are illustrated in FIG. 13 as the bus system 1322.

As used herein, the term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The various illustrative logical blocks, modules and circuits described herein may be implemented or performed with a general purpose processor, a digital signal processor (DSP), an application specific integrated circuit (ASIC), a field programmable gate array signal (FPGA) or other programmable logic device, discrete gate or transistor logic, discrete hardware components or any combination thereof designed to perform the functions described herein. A general purpose processor may be a microprocessor, but in the alternative, the processor may be any conventional processor, controller, microcontroller or state machine. A processor may also be implemented as a combination of computing devices, e.g., a combination of a DSP and a microprocessor, a plurality of microprocessors, one or more microprocessors in conjunction with a DSP core or any other such configuration.

The steps of a method or algorithm described herein may be embodied directly in hardware, in a software module executed by a processor or in a combination of the two. A software module may reside in any form of storage medium that is known in the art. Some examples of storage media that may be used include RAM memory, flash memory, ROM memory, EPROM memory, EEPROM memory, registers, a hard disk, a removable disk, a CD-ROM and so forth. A software module may comprise a single instruction, or many instructions, and may be distributed over several different code segments, among different programs and across multiple storage media. An exemplary storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

The functions described may be implemented in hardware, software, firmware, or any combination thereof. If implemented in software, the functions may be stored as one or more instructions on a computer-readable medium. A computer-readable medium may be any available medium that can be accessed by a computer. By way of example, and not limitation, a computer-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for measurement and feedback of channel quality indicator (CQI) information, the method being implemented by user equipment, the method comprising:
receiving configuration information indicating whether the user equipment provides feedback of the CQI information in virtual resource block mode or physical resource block mode;
if the configuration information indicates that the user equipment provides feedback in virtual resource block mode, calculating the CQI information for virtual resource blocks; and
feeding back the CQI information for the virtual resource blocks to a Node B.

2. The method of claim 1, wherein calculating the CQI information for a particular virtual resource block comprises:
calculating the CQI information for multiple physical resource blocks corresponding to the virtual resource block; and
determining the CQI information for the virtual resource block based on the CQI information that is calculated for the multiple physical resource blocks.

3. The method of claim 2, wherein determining the CQI information for the virtual resource block based on the CQI information that is calculated for the multiple physical resource blocks comprises averaging CQI values that are calculated for the multiple physical resource blocks.

4. The method of claim 2, wherein determining the CQI information for the virtual resource block based on the CQI information that is calculated for the multiple physical resource blocks comprises selecting a maximum CQI value from CQI values that are calculated for the multiple physical resource blocks.

5. The method of claim 2, wherein determining the CQI information for the virtual resource block based on the CQI information that is calculated for the multiple physical resource blocks comprises selecting a minimum CQI value from CQI values that are calculated for the multiple physical resource blocks.

6. The method of claim 1, wherein the configuration information is received via Radio Resource Control signaling.

7. The method of claim 1, wherein the configuration information comprises a virtual resource block flag that is included within physical uplink control channel (PUCCH) resource allocation.

8. The method of claim 1, wherein the configuration information comprises a virtual resource block flag that is included within physical downlink shared channel (PDSCH) resource allocation.

9. The method of claim 1, wherein the configuration information is received via L1/L2 signaling.

10. The method of claim 1, wherein the configuration information comprises a virtual resource block flag that is included within physical downlink control channel (PDCCH) control signaling.

11. User equipment that is configured for measurement and feedback of channel quality indicator (CQI) information, comprising:
a processor;
memory in electronic communication with the processor;
instructions stored in the memory, the instructions being executable to:
receive configuration information indicating whether the user equipment provides feedback of the CQI information in virtual resource block mode or physical resource block mode;
if the configuration information indicates that the user equipment provides feedback in virtual resource block mode, calculate the CQI information for virtual resource blocks; and
feed back the CQI information for the virtual resource blocks to a Node B.

12. The user equipment of claim 11, wherein calculating the CQI information for a particular virtual resource block comprises:
calculating the CQI information for multiple physical resource blocks corresponding to the virtual resource block; and
determining the CQI information for the virtual resource block based on the CQI information that is calculated for the multiple physical resource blocks.

13. The user equipment of claim 12, wherein determining the CQI information for the virtual resource block based on the CQI information that is calculated for the multiple physical resource blocks comprises at least one of:
averaging CQI values that are calculated for the multiple physical resource blocks;
selecting a maximum CQI value from the CQI values that are calculated for the multiple physical resource blocks; and
selecting a minimum CQI value from the CQI values that are calculated for the multiple physical resource blocks.

14. The user equipment of claim 11, wherein the configuration information is received via at least one of Radio Resource Control signaling and L1/L2 signaling.

15. The user equipment of claim 11, wherein the configuration information comprises a virtual resource block flag, and wherein the virtual resource block flag is included within at least one of:
physical uplink control channel (PUCCH) resource allocation;
physical downlink shared channel (PDSCH) resource allocation; and
physical downlink control channel (PDCCH) control signaling.

16. A Node B that configures user equipment (UE) to measure and provide feedback of channel quality indicator (CQI) information, comprising:
a processor;
memory in electronic communication with the processor;
instructions stored in the memory, the instructions being executable to:
send configuration information which indicates whether the UE provides feedback of the CQI information in virtual resource block mode or physical resource block mode;
receive the CQI information from UEs; and
decide a modulation and coding scheme that is used for data transmission for each UE based at least on the received CQI information and the configuration information.

17. The Node B of claim 16, wherein the configuration information is sent via at least one of Radio Resource Control signaling and L1/L2 signaling.

18. The Node B of claim 16, wherein the configuration information comprises a virtual resource block flag, and wherein the virtual resource block flag is included within at least one of:
physical uplink control channel (PUCCH) resource allocation;
physical downlink shared channel (PDSCH) resource allocation; and
physical downlink control channel (PDCCH) control signaling.

19. A computer-readable medium comprising executable instructions for:
receiving configuration information indicating whether user equipment provides feedback of channel quality indicator (CQI) information in virtual resource block mode or physical resource block mode;
if the configuration information indicates that the user equipment provides feedback in virtual resource block mode, calculating the CQI information for virtual resource blocks; and
feeding back the CQI information for the virtual resource blocks to a Node B.

20. The computer-readable medium of claim 19, wherein calculating the CQI information for a particular virtual resource block comprises:
calculating the CQI information for multiple physical resource blocks corresponding to the virtual resource block; and
determining the CQI information for the virtual resource block based on the CQI information that is calculated for the multiple physical resource blocks.

21. The computer-readable medium of claim 20, wherein determining the CQI information for the virtual resource block based on the CQI information that is calculated for the multiple physical resource blocks comprises at least one of:
averaging CQI values that are calculated for the multiple physical resource blocks;
selecting a maximum CQI value from the CQI values that are calculated for the multiple physical resource blocks; and
selecting a minimum CQI value from the CQI values that are calculated for the multiple physical resource blocks.

22. The computer-readable medium of claim 19, wherein the configuration information is received via at least one of Radio Resource Control signaling and L1/L2 signaling.

23. The computer-readable medium of claim 19, wherein the configuration information comprises a virtual resource block flag, and wherein the virtual resource block flag is included within at least one of:
physical uplink control channel (PUCCH) resource allocation;
physical downlink shared channel (PDSCH) resource allocation; and
physical downlink control channel (PDCCH) control signaling.
